(19) United States
(12) Patent Application Publication
(10) Pub. No.: US 2021/0192844 A1
(43) Pub. Date: Jun. 24, 2021

(54) Passive Data Capture-based Environment Generation

(71) Applicant: Wormhole Labs, Inc., Huntington Beach, CA (US)

(72) Inventors: Curtis Hutten, Laguna Beach, CA (US); Robert D. Fish, Irvine, CA (US); Brian Kim, Walnut, CA (US)

(21) Appl. No.: 17/127,667

(22) Filed: Dec. 18, 2020

Related U.S. Application Data
(60) Provisional application No. 62/952,177, filed on Dec. 20, 2019.

(51) Int. Cl. G06T 19/00

(52) U.S. Cl. CPC G06T 19/00

(57) ABSTRACT

A system that allows for a user to meet people in a real-world location without both people being present. The system allows for a user to see where a person they might like to meet is within a real-world environment via an avatar in a virtual environment. Users at a real-world location can also discover and meet users that are no longer there.

This application claims priority to U.S. provisional application 62/952,177, filed Dec. 20, 2019. U.S. provisional application 62/952,177 and all other extrinsic references contained herein are incorporated by reference in their entirety.

### FIELD OF THE INVENTION

The field of the invention is virtual and augmented reality social environments.

### BACKGROUND

The background description includes information that may be useful in understanding the present invention. It is not an admission that any of the information provided herein is prior art or relevant to the presently claimed invention, or that any publication specifically or implicitly referenced is prior art.

The growth of social media has provided users with the ability to virtually meet and establish relationships with people the might not have otherwise connected with. Many people still prefer to meet people the traditional way—in a real-life setting. However, in order to do so, this requires an individual to head to a physical location under the promise that there might be others that they are interested in meeting there, without being able to find out until they are actually there. Only then does the person have to put in the work to find people that they might actually wish to get to know. Additionally, the person might miss some of these people simply due to bad timing, where they arrive at a location after the people they might have otherwise connected with have already left.

Thus, there is still a need for a system that allows for a user to merge the virtual social elements into a real-life setting.

### SUMMARY OF THE INVENTION

The inventive subject matter provides apparatus, systems and methods in which a computing device receives a selection of a real-world location from a user, obtains data associated with a second user that's present at the real-world location (which includes a location of the second user within the real-world location, such as from the second user's computing device), displays to the first user a digital model of the real-world location and inserts a digital avatar associated with the second user into the digital model. The location of the digital avatar within the digital model is based at least in part on the second user's actual location in the real-world location.

In embodiments of the inventive subject matter, the data associated with the second user also includes attributes associated with the second user. In these embodiments, the computing device attempts a match between the embodiments of the second user and attributes of the first user and, if the computing device determines that a match exists, the second user's digital avatar is inserted into the digital model.

In embodiments of the inventive subject matter, a user can opt out of the use of certain attributes in the matching. For example, a second user at the real-world location can opt out of having certain attributes of theirs used in a potential match. In these embodiments, the computing device determines whether a match between the first and second users exists based on the available attributes (i.e., the attributes that have not been opted out).

In embodiments of the inventive subject matter, the attributes used to perform matches are obtained from publicly-available sources.

In embodiments of the inventive subject matter, the digital avatar that is inserted into the digital model is generated based at least in part on the corresponding user's attributes. For example, the appearance of the avatar can be modified based on the second user's (the user at the physical location) attributes.

In embodiments of the inventive subject matter, the computing device displays information about the second user near the inserted corresponding digital avatar. The displayed information is based on the data about the second user obtained by the computing device.

In embodiments of the inventive subject matter, a second user at the real-world location can anonymize the appearance of their digital avatar on the first user's screen. In these embodiments, the computing device can, in response to a request to anonymize the avatar, display the avatar at a random location within the digital model. If the second user later wishes to remove the anonymity, he/she can submit a request to remove the anonymity to the computing device. In response to this request, the computing device then places the second user's digital avatar in the correct place within the digital model that corresponds to the second user's actual location within the real-world environment.

In embodiments of the inventive subject matter, the data about the second user obtained by the computing device includes time information indicating when the second user was last at the real-world location (e.g., an elapsed time since the second user left the real-world location). In these embodiments, the first user is at the real-world location and is capturing image data of the real-world location using a camera on his/her mobile computing device. In these embodiments, the computing device assembles an augmented reality view of the real-world location for the first user and presents the digital avatar of the departed second user within the augmented reality view. The presentation of the digital avatar within the digital model can be adjusted based on the elapsed time since the user was at the real-world location.

In further embodiments of the inventive subject matter, if the second user that has left the real-world location is still within a pre-determined distance, the computing device can provide an indication to the first user. In embodiments, this can be a visual indication. In other embodiments, the indication can be a non-visual sensory output.

In embodiments of the inventive subject matter, the computing device can present a communication interface that allows the users to communicate with one another.

Various objects, features, aspects and advantages of the inventive subject matter will become more apparent from the following detailed description of preferred embodiments, along with the accompanying drawing figures in which like numerals represent like components.

All publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

### BRIEF DESCRIPTION OF THE DRAWING

FIG. 1 is an overview of the system according to embodiments of the inventive subject matter.

FIG. 2 is a flowchart of a process according to embodiments of the inventive subject matter.

FIG. 3 is a photograph illustrating a real-world location as used within embodiments of the inventive subject matter.

FIG. 4 is an illustrative example of a rendered digital model of the real-world location of FIG. 3.

FIG. 5 illustrates an embodiment whereby an information box is presented.

FIG. 6 illustrates a prompt to initiate user contact, according to embodiments of the inventive subject matter.

FIG. 7 shows an embodiment where users at a real-world location can be anonymously represented to the user.

FIG. 8 shows an overview of a system for facilitating missed connections according to other embodiments of the inventive subject matter.

FIG. 9 is a flowchart of a process executed by the system of FIG. 8, according to embodiments of the inventive subject matter.

FIG. 10 illustrates a real-world environment as seen through a camera of a user's computing device.

FIG. 11 shows the real-world environment of FIG. 10 with an indication of where a second user's computing device was in the past.

FIG. 12 illustrates an augmented-reality environment generated according to embodiments of the inventive subject matter.

FIG. 13 illustrates an embodiment where a user's avatar is modified based on how long ago they left the real-world location.

FIG. 14 illustrates a generated communication prompt, according to embodiments of the inventive subject matter.

### DETAILED DESCRIPTION

The following description includes information that may be useful in understanding the present invention. It is not an admission that any of the information provided herein is prior art or relevant to the presently claimed invention, or that any publication specifically or implicitly referenced is prior art.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

It should be noted that any language directed to a computer should be read to include any suitable combination of computing devices, including servers, interfaces, systems, databases, agents, peers, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

The following discussion provides many example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

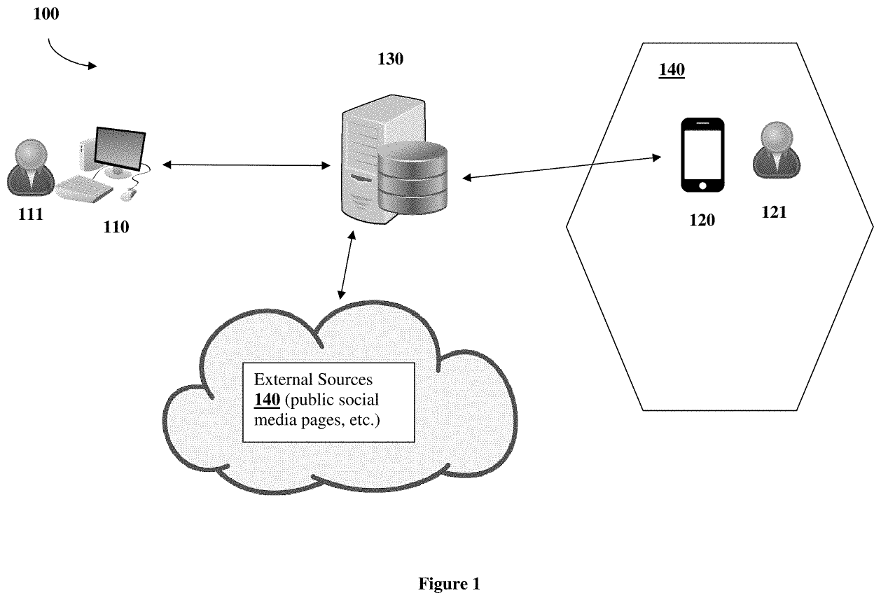

FIG. 1 provides an overview of the various components of the system 100, according to embodiments of the inventive subject matter.

As seen in FIG. 1, a first user 111 accesses the functions of the system 100 via their computing device 110. A second user 121 can also interact with the system 100 via their computing device 120. The computing devices 110, 120 communicate with server 130, which executes various functions associated with the inventive subject matter discussed herein.

As seen in FIG. 1, user 121 and computing device 120 are within a real-world location 140. The computing device 120 sends location data regarding its real-world position to the server 130.

The computing devices 110, 120 include at least one processor, communications components that allow for data exchanges with the server 130 and other computing devices, input/output components (e.g., monitors, touchscreens, keyboards, mouse, stylus, speakers, microphones, etc.), and non-transitory, physical memory (e.g., RAM, ROM, etc.) to store computer-executable instructions to carry out the various functions discussed herein. The computing devices 110, 120 can also include location determination components (e.g., GPS, cellular triangulation, etc.) to perform various functions as discussed herein. Examples of computing devices 110, 120 include desktop computers, laptop computers, cell phones, smart phones, tablets, video game consoles, smart watches, etc.

The real-world location 140 can be a commercial location or other public location. Examples of these types of real-world locations can include bars, restaurants, theaters, libraries, night clubs, museums, etc. A real-world location 140 can also be a location that is designated via geofencing or other means of designating an area as a particular, specified location. This location can be temporary (e.g., a weekly cars and coffee meeting or flea market) or permanent (e.g., an area surrounding a park or monument designated as a “location” within a map application).

To access the functions of the system 100, participating devices such as the computing devices 110, 120 may have an application installed that acts as a portal or gateway into the system.

It should be noted that while only two computing devices 110, 120 are illustrated in FIG. 1 for the sake of simplicity, the system is capable of interacting with many computing devices associated with many users.

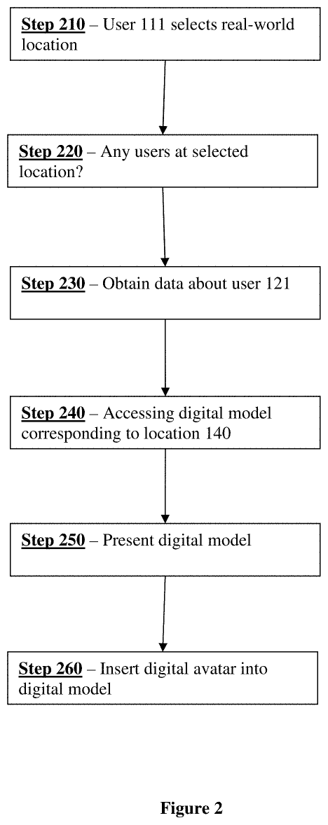

FIG. 2 provides a diagram of the processes executed according to the inventive subject matter.

At step 210, the first user 111 selects a real-world location via computing device 110. This can be performed via a search, via a map application, etc.

At step 220, the server 130 determines whether any users of the system are present at the selected real-world location 140 based on location information received from those users' computing devices. In this example, computing device 120 associated with user 121 is within the real-world location. Thus, at step 220, the server 130 receives location data from computing device 120 and determines that it is within the real-world location 140.

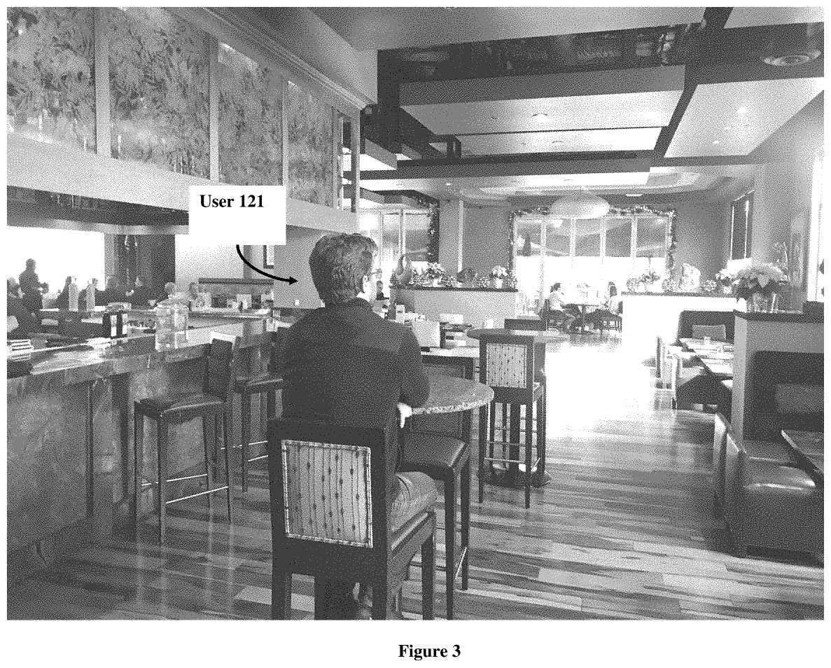

FIG. 3 provides a photograph illustrating a user 121 within a real-world location 140 (in this case, a restaurant).

Having identified computing device 120 associated with user 121 is within the real-world location 140, the server 130 proceeds to obtain data about user 121 at step 230. The data about user 121 can include information about their interests, opinions, preferences, etc.

In embodiments, all the additional data (beyond the location data) about a user is retrieved by the server 130 from external sources 140 (e.g., social media, websites and other online sources of information). In a variation of these embodiments, the data gathered by the server 130 can be obtained from publicly available sources (e.g., public websites, public social media accounts, public social media posts, public records, etc.). As such, in these environments, the participation of one or more of the user 111 and 121 within the system 100 could be considered to be “passive” because, other than the location data provided by each user's computing device 110, 120, one or more of the users 111, 121 are not actively providing any information to the system 100.

In other embodiments, some or all of the data about a user that is retrieved by the server 130 can be stored by the server 130 or other computing device(s) under the control of the system 100, entered by the user 121 as part of the use of the system 100 (e.g., during registration with the system or sometime thereafter).

In embodiments, the data obtained about a user can be in the form of attributes that reflect characteristics of that user. The attributes can be reflective of the user's physical characteristics, heritage, beliefs, tastes, interests, opinions, preferences, etc. Examples of attributes can include age, gender, race, religious preferences, political preferences, music preferences (e.g., favorite genres, bands, songs, etc.), movie/TV preferences, sports preferences, food preferences, etc.

At step 240, the server 130 accesses a digital model of the real-world location 140. The digital model can be a three-dimensional digital model that accurately represents the real-world location 140. Though a three-dimensional model is preferred, in embodiments the model can be a two-dimensional model.

In these embodiments, the server 130 first checks the real-world location 140 for any computing devices reporting their location at step 220, then obtains any additional data regarding the user(s) of computing device(s) within the real-world location at step 230 and then accesses the digital model of the real-world location 140 at step 240 upon determining that one or more devices are present and the additional data has been retrieved. However, in other embodiments, the server 130 can reverse the order of these steps and first retrieve the digital model of the real-world location 140 at step 240 before or simultaneously with the step of checking for participating devices within the real-world location at step 220 and/or the step of retrieving additional data about the users at step 230.

At step 250, the digital model of the real-world location 140 is displayed to the user 111 via their computing device 110.

In embodiments, some or all of the rendering of the digital model is performed by the server 130. Thus, imagery regarding the digital model is then streamed to the computing device 110 for display. As such, subsequent interactions of the user with the digital model are transmitted back to the server 130 and executed by the server 130. In other embodiments, some or all of the rendering of the digital model is performed by the computing device 110. In these embodiments, the data needed to render and display the digital model is transmitted to the computing device 110 and executed locally by the computing device 110. In still other embodiments, the processing required to render the model can be divided between the server 130 and computing device 110 such that the digital model is rendered and then displayed to the user 111 via the screen of the computing device 110.

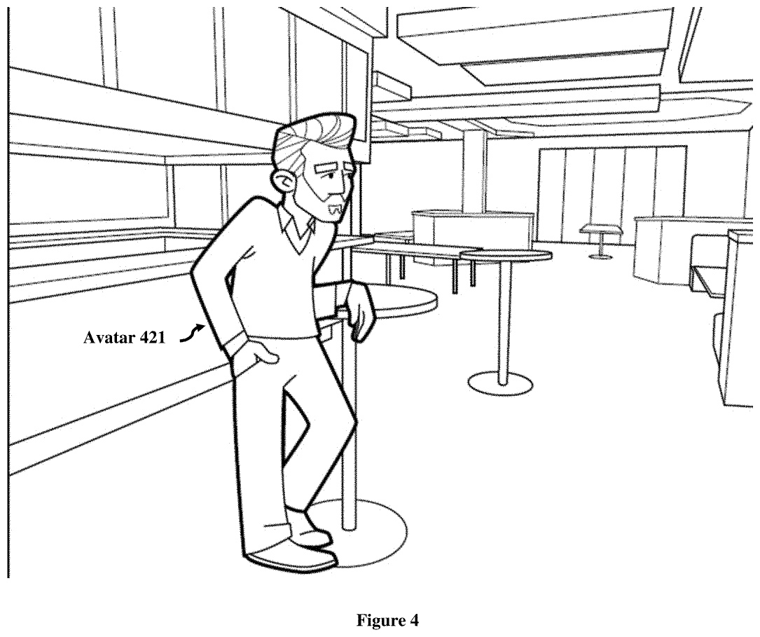

At step 260, the system 100 (the server 130, the mobile device 110, or both in combination, depending on which device(s) are handing the processing associated with generating and presenting the digital model) inserts a digital avatar corresponding to the user 121 into the digital model. FIG. 4 provides an illustrative example of a rendered digital model of the restaurant from FIG. 3 with an avatar 421 inserted into the digital model of the restaurant at the location corresponding to the real-world position of user 121 in the real-world restaurant.

The generation of a three-dimensional digital model representative of a real-world environment and inserting a virtual avatar therein is known in the art. Examples of suitable techniques are discussed in US pre-grant publication number 2010/0277468 to Lefevre, et al, US pre-grant publication number 2002/0140745 to Ellenby, et al and international application publication number WO 98/46323 to Ellenby, et al.

The fidelity of the digital model can vary on a number of factors such as available processing power, available network capabilities, the complexity of the real-world location being modeled, etc. The digital model presented to the user 111 can thus, in certain embodiments, be a photo-realistic recreation of the real-world location 140. In other embodiments, the digital model can be a stylized recreation of the real-world location (e.g., have a “cartoony” look, presented with different colors, lighting effects, etc.). In other embodiments, the digital model can be a lower-resolution or “blockier” version of the real-world location 140 such that the three-dimensional space of the real-world location is appropriately represented without requiring additional processing to render unnecessarily elements. Likewise, the depiction of the contents of a real-world location can depend on the frequency that the digital model is updated. In certain embodiments, the static elements that are modeled will be accurately reflected in the digital model. However, other elements that are temporary or movable might not be accurately modeled or represented in the model at all. For example, in the illustrated example of FIG. 4, the chairs, bottles at the bar, and other temporary elements are not shown in the digital model because they are not part of the model when it is generated/updated since their location within the real-world location can change so frequently. In this example, however, the tables are considered to be fixed and as such are reflected in the digital mode. As such, the avatar 421 appears to be standing near a table in the same location within the digital model as the user 121 is sitting in the chair in the real-world location 140 in FIG. 3.

In embodiments, the appearance of the digital avatar can be selected by the user which the avatar represents. Thus, the user can customize the avatar that will represent them within a digital model. In embodiments, the avatar corresponding to the user 121 of computing device 120 can be generated based on attributes associated with the user 121 of computing device 120. For example, if the user of computing device 120 has a favorite sports team, the avatar could be modified to appear to sport the jersey of the sports team.

In embodiments, the server 130 performs a match based on the attributes associated with the user 111 and the users within a real-world environment and only generates avatars for those users whose attributes match with those of user 111. Based on an analysis of the attributes of the user 111 against those of the users of other computing devices determined to be within the real-world location 140 (e.g., via a statistical or other matching algorithm), the server 130 determines which of the users within the real-world location 140 meet a matching threshold with the user 111. The server 130 then only generates and inserts an avatar for the matching users at step 260. This way, in a crowded real-world space, the user 111 is only presented with avatars of those people that they are most likely to want to meet.

In embodiments, a user can opt out from having the server 130 retrieve information about them. In certain embodiments, the user can opt out from having any information about them used by the server 130 in the functions and processes discussed herein. In other embodiments, a user can opt out of having certain attributes be retrieved and used by the server 130. For example, a user may not wish to have their sports team preference, religion, or political affiliations be used as criteria for a match. As such, they can specify within the system (such as via the application installed on their computing device) to have those attributes excluded from the matching process. This request is interpreted by the server 130 as a command to exclude those attributes from matching consideration. In response to receiving this command, the server 130 performs the matching without considering those attributes. If at some point the user wishes to opt back in, the user can, via their computing device, issue a command to the server 130 to opt in to having those attributes considered.

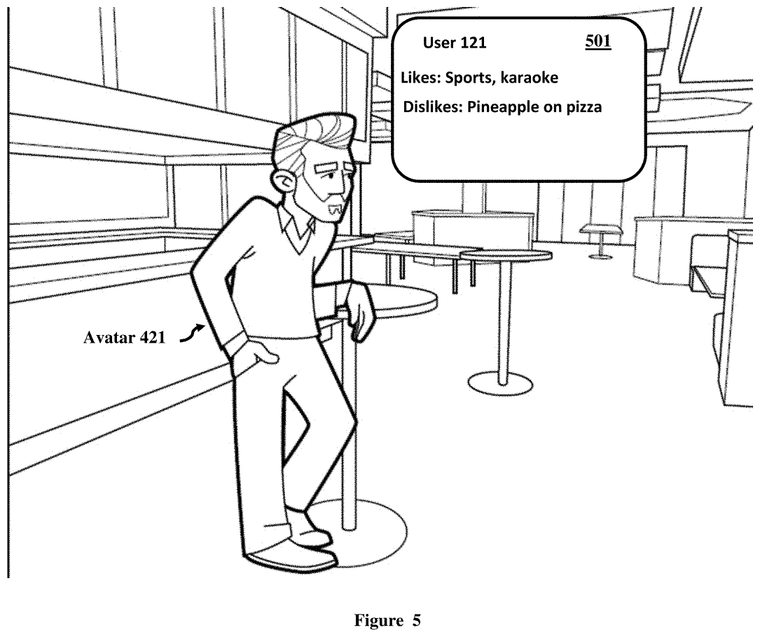

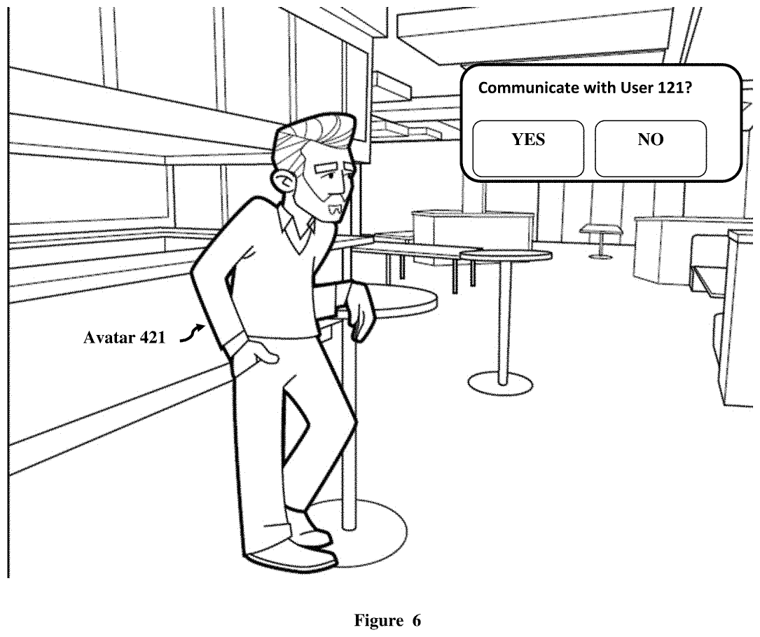

In certain embodiments, the system 100 can provide a user 111 with information about the user 121. In these embodiments, the system 100 can provide certain information about the user 121 for display by the computing device 120. For example, as shown in FIG. 5, the computing device 120 displays information box 501 that includes some “likes” and “dislikes” of user 121 represented by avatar 421. The information box 501 also shows an identification of the user 121. This can be a user's real name, a user-selected screen name, a system-provided screen name, or other identifying information. The information can be provided by the users and/or obtained from publicly available sources (e.g., public social media pages/posts, public records, etc.). In embodiments, the information can include contact information and a link or button to establish communication. In embodiments, a prompt to contact the user 121 of avatar 421 can be provided with or without other information, as seen in FIG. 6.

In embodiments, the avatar shown can represent an employee or representative of a business establishment and the information can be reviews about the person (e.g., user reviews for a particular bartender), contact information for the business, or other information relevant to the business establishment at the real-world location 140.

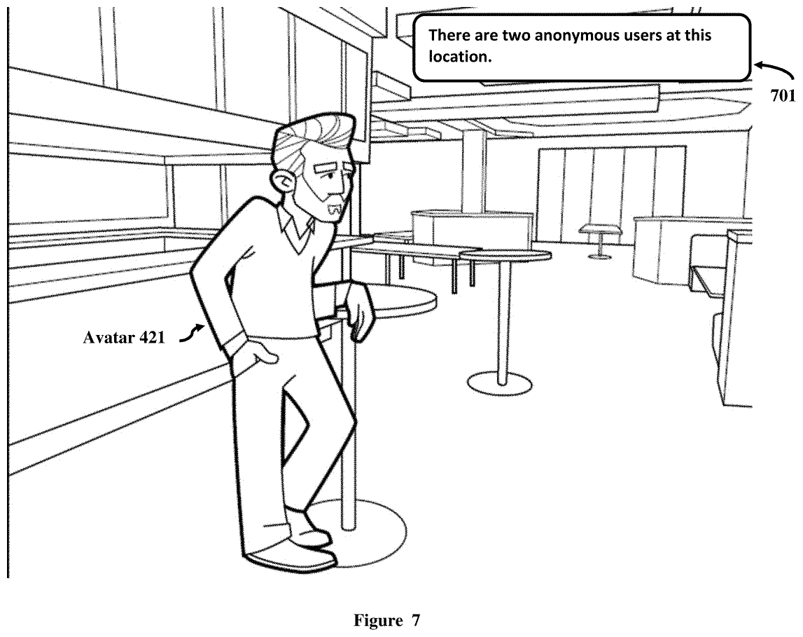

In certain embodiments, a user at a real-world location 140 can request that the server 130 anonymize their location within the real-world location 140 to other users. Upon receiving this request, the server 130 will remove the location information from the generation of the avatar to be inserted into the digital model of the real-world location 140. As such, the presence of the avatar within the digital model is still presented to the user via computing device 110, but the exact location of the avatar within the digital model (that reflects the actual location of the computing device 120 within the real-world environment 140) is not reflected in the avatar. In embodiments, this is represented by simply presenting a message to the user 111 via computing device 110 that the avatar is present without actually showing the avatar anywhere in the digital model. For example, FIG. 7 shows the avatar 421 representing the user 121 as before, but also includes a notification 701 that there are other users that are remaining anonymous within the location. In other embodiments, this is represented by having the avatar randomly placed within the digital model. In these embodiments, the avatar can be marked or otherwise modified when displayed within the digital model to let the user 111 know it is a random placement and avoid misleading the user 111 into thinking that an actual person is at that location of the real-world environment.

If a user that has anonymized their location wishes to have their avatar actually reflect their real location within the real-world location 140, they can send a request to the server 130 to rescind the request to anonymize their location. Upon receiving this request, the server 130 removes the restriction on using the location of computing device 120 in generating the avatar. As such, the avatar is generated at step 260 and inserted into the digital model at a location within the model corresponding to the real-world location of the computing device 120 within the real-world location 140.

In embodiments of the inventive subject matter, the system can enable a user at a real-world location to find so-called “missed connections”; other interesting people that were recently at the location but no longer there. In these embodiments, the system uses augmented reality (“AR”) functions to enable a user at a particular real-world location to find people that they might find interesting that were recently at the real-world location.

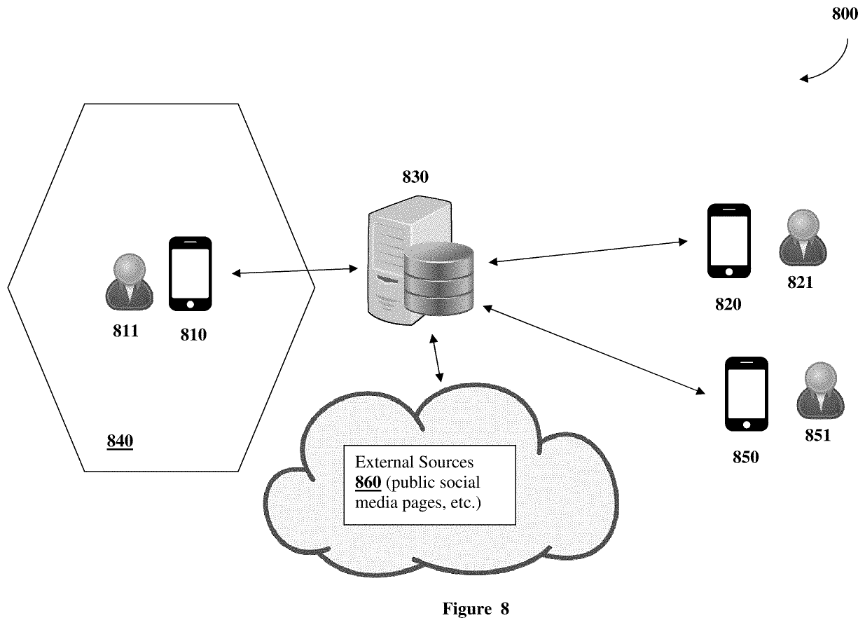

As shown in FIG. 8, the system 800 of these embodiments include a plurality of computing devices 810, 820 that can communicate with a server 830. The computing devices 810, 820 that participate within system 800 can do so via an installed application that enable the computing devices 810 to execute the various functions of the inventive subject matter.

The computing devices participating within system 800 provide their location data to the system 800 so that the system 800 can determine not only where the devices currently are located, but where they have been in the recent past. To do so, the users of each of the devices can activate the installed application such that, when the application is active, it periodically transmits the device's location to the server 830. As the device transmits its location when a user of a device moves from one real-world location to another, the server 830 will know where the device is currently located in the real world as well as where it has recently been.

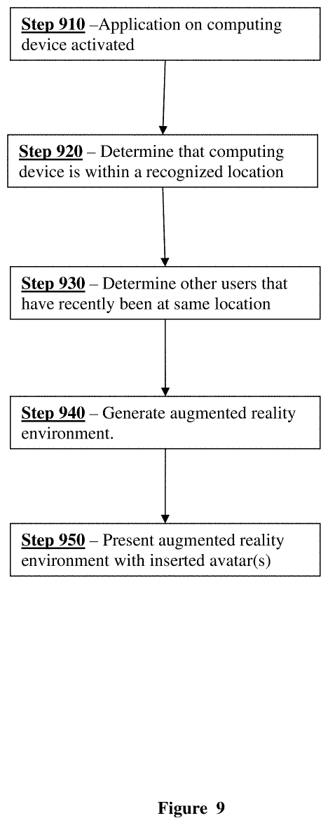

FIG. 9 provides a flowchart of the functions and processes of these embodiments of the inventive subject matter.

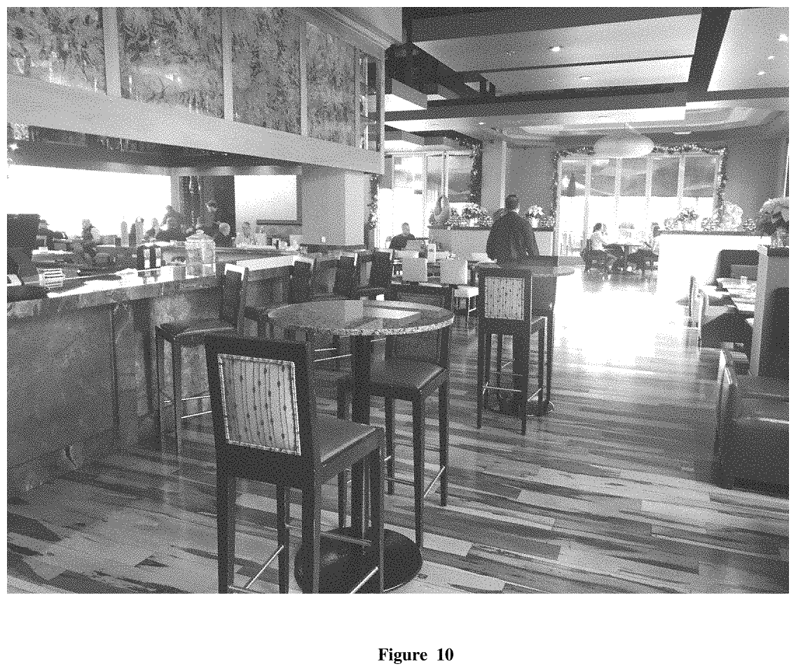

At step 910, the user activates an application on his computing device 810 (e.g., a mobile device) that uses the device's camera to capture images of the real-world environment 840 around the user. FIG. 10 illustrates the real-world environment 840 as seen through the camera of computing device 810, prior to the generation of the augmented reality environment. In this example, the real-world environment is a restaurant.

At step 920, the server 830 determines that the computing device 810 is within a recognized real-world location 840. This can be performed based on location data (e.g., GPS data) provided to the server 830 by the computing device 810. In embodiments, the real-world location can also be determined based on image recognition analysis of the images captured by the camera of computing device 810.

At step 930, the server 830 determines whether any other users of the system have been at that same real-world location within a pre-determined recent period of time (e.g., within the last hour, the last 10 hours, the last day, the last week, etc.).

Having identified that computing device 820 meets the criteria at step 930, the computing device 810 generates an augmented reality environment whereby an avatar representing the user of computing device 820 is overlaid within the images captured by the camera at step 940. The augmented reality environment including the avatar is then presented to the user at step 950.

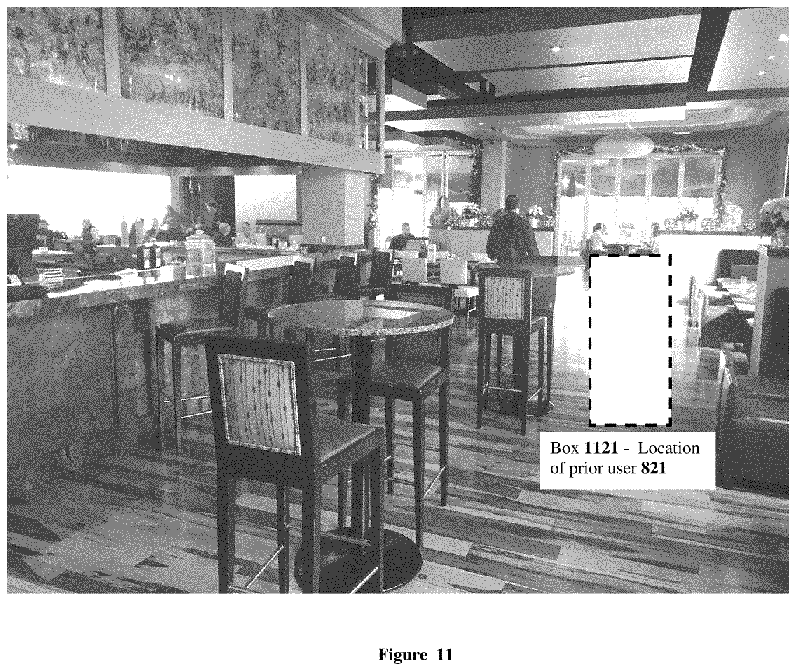

FIG. 11 illustrates the real-world environment of FIG. 10, with an indication of where a computing device 820 (and therefore, a corresponding user 821) was located within the real-world environment represented by the broken-line box 1121. It should be noted that box 1121 is not shown to the user 811 via device 810; rather, the box 1121 is shown here for demonstrative purposes for ease of understanding.

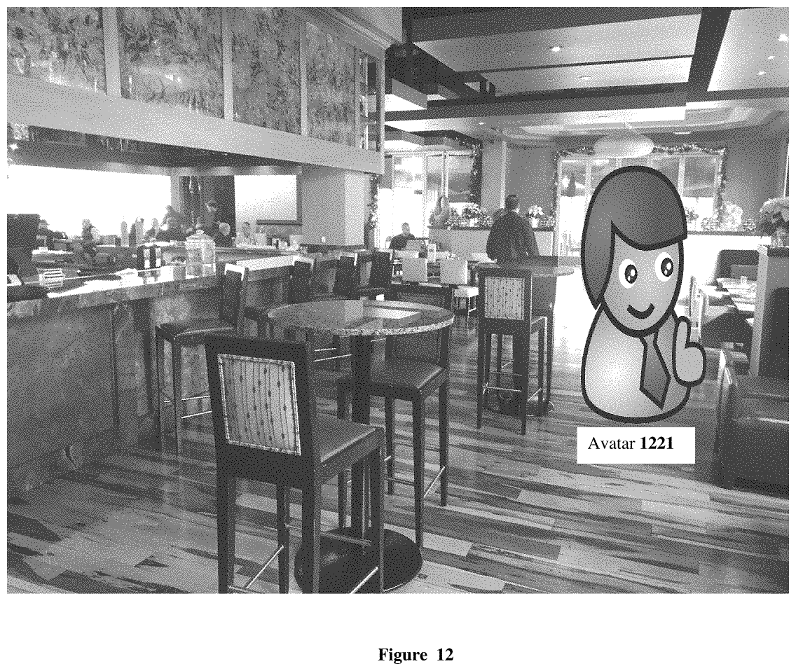

FIG. 12 provides an illustrative example of the augmented reality environment as seen by user 811 on device 810, showing the avatar 1221 representing user 821. As seen in FIG. 12, the avatar 1221 is depicted so as to appear to be in the same location within the real-world restaurant as the user 821 was recently, as represented by the box 1121 in FIG. 8.

As with the embodiments discussed above, the avatar corresponding to the user of computing device 820 can be generated based on attributes associated with the user of computing device. The attributes include the location of the computing device 820 while it was at the real-world location 840, which is used to place the avatar within the augmented reality environment. Other attributes can be used to modify or otherwise customize the appearance of the avatar within the augmented reality environment. For example, if the user of computing device 820 has a favorite sports team, the avatar could be modified to appear to sport the jersey of the sports team.

Similar to the embodiments discussed above, the system of these embodiments can, in certain embodiments, match users based on attributes corresponding to the various users. In these embodiments, the server 830 performs a match based on the attributes associated with the user 811 and the users that were recently within the real-world environment 840 and only generates avatars for those users whose attributes match with those of user 811. Based on an analysis of the attributes of the user 811 against those of the users of other computing devices determined to have recently been within the real-world location 840, (e.g., statistical or other matching algorithm), the server 830 determines which of the users recently at the real-world location 840 meet a matching threshold with the user 811. The server 830 then only generates and inserts an avatar for the matching users at step 950. This way, the user 811 is only presented with avatars of those people that they are most likely to want to meet.

In embodiments, all the additional data (beyond the location data) about users is retrieved by the server 830 from external sources 860 (e.g., social media, websites and other online sources of information). In a variation of these embodiments, the data gathered by the server 830 can be obtained from publicly available sources (e.g., public websites, public social media accounts, public social media posts, public records, etc.). As such, in these environments, the participation of users 811, 821, 851 within the system 800 could be considered to be “passive” because, other than the location data provided by user computing devices 810, 820, 850 the individual users are not actively providing any information to the system 800.

In embodiments, the presentation of the avatar within the augmented reality environment can be modified based on the time elapsed since the user of the computing device 820 was at the real-world location. For example, the avatar is modified such that appears to fade as time elapses. Thus, for a user most recently at the real-world location, the avatar would appear to be bolder and clearer. As time elapsed, the avatar would gradually fade (e.g., become more transparent and/or otherwise less visible within the augmented reality environment). When the pre-determined threshold of time of step 930 is reached, the avatar disappears altogether.

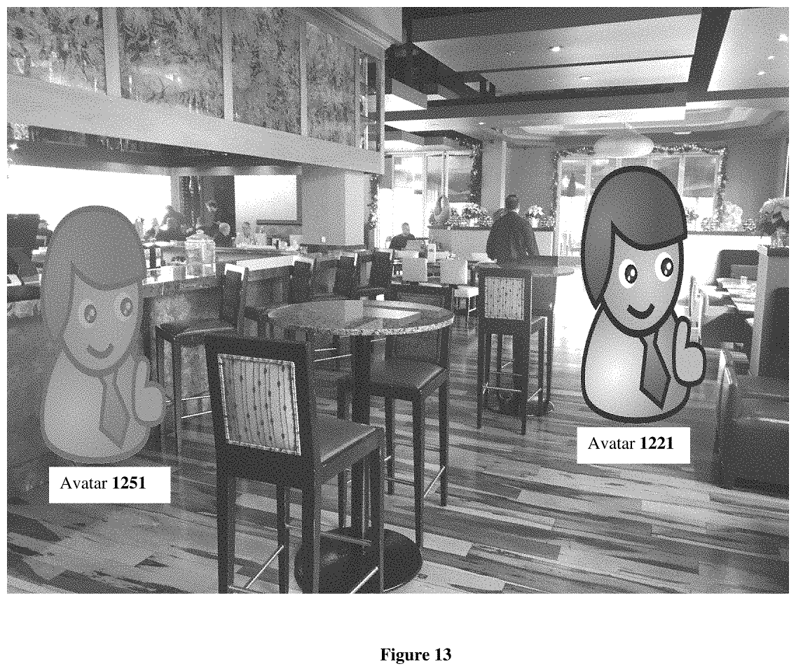

FIG. 13 illustrates these embodiments. In FIG. 13 the avatar 1221 corresponding to user 821 is shown as it was seen in the embodiment of FIG. 9. FIG. 13 also illustrates an avatar 1251 corresponding to another user 851 of another computing device 850 whose avatar has been fading since it has been a longer time since the user 851 was at the restaurant.

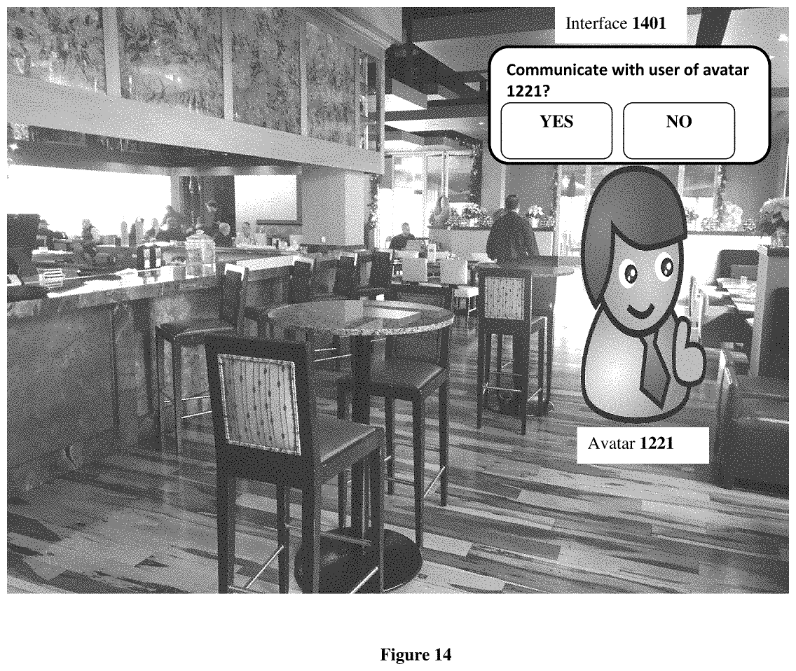

In embodiments, the presentation of the avatar within the augmented reality environment can include presenting a communication interface 1401 that enables a user 811 of computing device 810 to contact the user 821 of computing device 820, as seen in FIG. 14. The communication interface can enable a user of computing device 810 to request contact with the user of computing device 820 before allowing the user to send any messages. Alternatively, the user of device 810 can send a message to the user of computing device 820 without first requiring permission from the user of computing device 820.

In a variation of these embodiments, the system can generate the communication interface based on a current location of the computing device 820. For example, if a user of computing device 810 interacts with the avatar 1221 associated with the user of computing device 820 within the augmented reality environment, the server 830 obtains the current location of the computing device 820. This can be obtained via a regular “checking in” by the computing device 820 with its location data to the server 830 or by the server 830 sending a message to computing device 820 requesting its location (e.g., in situations where the system application of computing device 820 is not active). Upon receiving the location of the computing device 820, the server 830 checks to determine whether the computing device 820 is within a certain threshold distance of the real-world location. If the location of the computing device 820 is within the threshold distance of the real-world location, the server 830 communicates this to the computing device 810, which generates and presents the communication interface that enables the user of computing device 810 to communicate with the user of computing device 820.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

What is claimed is:

1. A system for augmented reality presence, comprising:
a computing device programmed to:
receive a selection of a real-world location from a first user;
obtain data associated with at least one second user currently present at the real-world location, the data include a location of the at least second user within the real-world location;
display, to the first user, a digital model of the real-world location; and
insert, within the displayed digital model, a digital avatar corresponding to the at least second user, wherein the digital avatar is inserted within the digital model based on the real-world location of the at least second user within the real-world location.

2. The system of claim 1, where the location data associated with the at least one second user is obtained from a second computing device associated with the at least one second user.

3. The system of claim 1, wherein the data associated with the at least one second user further comprises attributes associated with the second user, and wherein the computing device is further programmed to:
attempt to match the first user with the at least one second user based on attributes associated with the first user and the attributes associated with the second user attributes; and
wherein the inserting of the digital avatar is based on a successful matching.

4. The system of claim 3, wherein the computing device is programmed to:
receive, from a second computing device associated with the at least one second user, an opt out command regarding one or more of the attributes associated with the second user; and
performing the attempt to match of the first user and the at least one second user without the opted-out attributes.

5. The system of claim 1, wherein the data associated with the user further comprises attributes associated with the second user and wherein the attributes are derived from information associated with the user obtained from publicly available sources.

6. The system of claim 1, wherein the data associated with the user further comprises attributes associated with the second user and wherein the computing device is further programmed to generate the digital avatar based at least in part on the attributes associated with the at least one second user.

7. The system of claim 1, wherein the computing device is further programmed to display information about the at least one second user near the inserted digital avatar, wherein the displayed information is based on the obtained data.

8. The system of claim 1, wherein the real-world location comprises a commercial space.

9. The system of claim 1, wherein the computing device is further programmed to:
receive, from a second computing device associated with the at least one second user, a command to anonymize the digital avatar within the digital model;
in response to receiving the command, insert the digital avatar at a random location within the digital model.

10. The system of claim 9, wherein the computing device is further programmed to:
receive, from the second computing device, a second command to cancel the prior command to anonymize the digital avatar within the digital model; and
in response to receiving the second command, insert the avatar within the digital model based on the real-world location of the at least second user within the real-world location.

11. A system for locating users across time within an augmented reality environment, comprising:
at least one non-transitory computer-readable storage medium storing instructions that, when executed by at least one processor, cause the at least one processor to:
receive an image of a real-world location captured by a camera of a mobile device associated with a first user;
obtain, from a server, data corresponding to at least one second user based on the real-world location, the data including time information regarding a recent visit by the at least one user to the real-world location;
cause the mobile device to generate an augmented reality environment by overlaying a digital avatar associated with the at least one second user within the image of the real-world location based on the obtained data including the time information; and
cause the mobile device to present the generated augmented reality environment to the first user via a display screen.

12. The system of claim 11, further comprising instructions that cause the at least one processor to:
cause the mobile device to present an interface to the first user that enables a first user to contact the at least one second user.

13. The system of claim 11, wherein the data corresponding to the at least one user further includes attributes associated with the at least one second user and the digital avatar is generated based on the attributes associated with the at least one second user.

14. The system of claim 11, wherein the data associated with the at least one second user further comprises attributes associated with the at least one second user, and further comprising instructions that cause the at least one processor to:
attempt to match the first user with the at least one second user based on attributes associated with the first user and the attributes associated with the second user attributes/criteria; and
cause the mobile device to overlay the digital avatar is based on a successful matching.

15. The system of claim 11, wherein the time information comprises an elapsed time since the at least one second user was present at the real-world location and further comprising instructions that cause the at least one processor to cause the mobile device to adjust an appearance of the digital avatar within the augmented reality environment based on the elapsed time.

16. The system of claim 15, wherein adjusting the appearance of the digital avatar further comprises fading the digital avatar within the augmented reality environment based on the elapsed time.

17. The system of claim 11, further comprising instructions that cause the at least one processor to:
obtain location information from the mobile device associated with the first user;
obtain, from the server, data corresponding to at least one third user, the data including time information regarding a recent visit of the at least one third user and location information corresponding to the location of a mobile device of at least one third user during the recent visit;
determine that the location information obtained from the mobile device associated with the first user and the location information corresponding to the location of the mobile device of the at least one third user meets a distance threshold; and
in response to determining that the distance threshold is met, cause the mobile device associated with the first user to provide a non-visual sensory output.

18. The system of claim 11, wherein the data corresponding to at least one second user further includes location information corresponding to the location of the at least one second user within the real-world location during the recent visit and further comprising instructions that cause the at least one processor to overlay the digital avatar within the image of the real-world location based on the time information and the location information.

19. The system of claim 11, further comprising instructions that cause the at least one processor to:
transmit a request to a second mobile device associated with the at least one second user, the request comprising a request for the current location of the second mobile device;
receiving, from the second mobile device, the current location of the second mobile device;
determining that the current location of the second mobile device is within a threshold distance of the real-world location; and
cause the mobile device to prompt the first user with an interface to contact the at least one second user.
